(19) United States
(12) Patent Application Publication
(10) Pub. No.: US 2002/0053851 A1
(43) Pub. Date: May 9, 2002

(54) ELECTRIC MACHINE, IN PARTICULAR THREE-PHASE ALTERNATOR

(76) Inventor: HELMUT KREUZER, SCHWIEBERDINGEN (DE)

Correspondence Address: STRIKER STRIKER & STENBY, 103 EAST NECK ROAD, HUNTINGTON, NY, 11743, US

(21) Appl. No.: 09/486,307

(22) PCT Filed: Jul. 9, 1998
(86) PCT No.: PCT/DE98/01914

(30) Foreign Application Priority Data
Aug. 29, 1997 (DE) 197 37 681.9

(51) Int. Cl. H02K 1/00

(52) U.S. Cl. 310/179

(57) ABSTRACT

The invention relates to an electric machine, in particular a three-phase generator, with a winding packet that can be penetrated by a rotating magnetic field, wherein a number of windings of the winding packet are respectively connected together into at least one phase at which a generator voltage can be tapped, and the windings are comprised of at least three parallel wound winding wires.

The provision is made that the parallel connected winding wires (33, 42) of a phase (U, V, W, U′, V′, W′) are divided and connected to at least two separate phase terminals (34, 36, 38, 34′, 36′, 38′) at each of which a partial generator voltage (u, v, w, u′, v′, w′) can be tapped.

The invention relates to an electric machine, in particular a three-phase generator, with the characterizing features mentioned in the preamble to claim 1.

### PRIOR ART

Electric machines that are embodied as three-phase generators are known. These are used, for example, for supplying power to the electrical system in motor vehicles. In this connection, an excitation winding disposed on a rotor is excited with a direct current. This produces a magnetic field, which is conducted to alternatingly disposed claw poles of a claw-pole rotor. Through the alternating disposition of the claw poles, the north and south poles of the magnetic field alternate with one another. The claw-pole rotor is encompassed by a stator which has a winding packet. In a three-phase generator, this winding packet is comprised of windings that are connected together in three-phase fashion, which are penetrated by the magnetic field in accordance with the rotation of the claw-pole rotor. This induces a voltage in the winding packet, which is tapped as the generator voltage in the windings that are respectively connected together into one phase. A three-phase generator that is constructed in this manner is described, for example, in DE 34 08 394 A1.

German Patent 254 680 has disclosed forming the windings of a winding packet from winding wires that are connected to one another in parallel.

### ADVANTAGES OF THE INVENTION

The electric machine according to the invention, with the features mentioned in claim 1, offers the advantage that depending on the wiring of the winding packet, different levels of generator voltage can be tapped. By virtue of the fact that at least two of the at least three parallel wound winding wires of a phase are respectively connected to separate phase terminals, at each of which a respective partial generator voltage can be tapped, a partial generator voltage can be supplied as needed at the phase terminals associated with each phase. In a preferable embodiment of the invention, the provision is made that in order to tap a total generator voltage that is made up of the partial generator voltages, the phase terminals of a phase can be connected in series. By means of this, it is easily possible for the parallel wound windings to be connected in series by way of a switching means in order to thus produce a higher generator voltage when needed.

By and large, it is possible through simple means, which can be realized without intervention into the structural embodiment of the electric machine, to use an electric machine to supply different levels of generator voltage.

Other advantageous embodiments of the invention ensue from the remaining features that are mentioned in the dependent claims.

### DRAWINGS

The invention will be explained in detail below in exemplary embodiments in conjunction with the accompanying drawings.

FIG. 1 is a schematic, partial view of a three-phase generator;

FIG. 3 is an enlarged detail from the partial view, and

FIGS. 2, and 4 to 6 show wiring variations of the three-phase generator.

### DESCRIPTION OF THE EXEMPLARY EMBODIMENTS

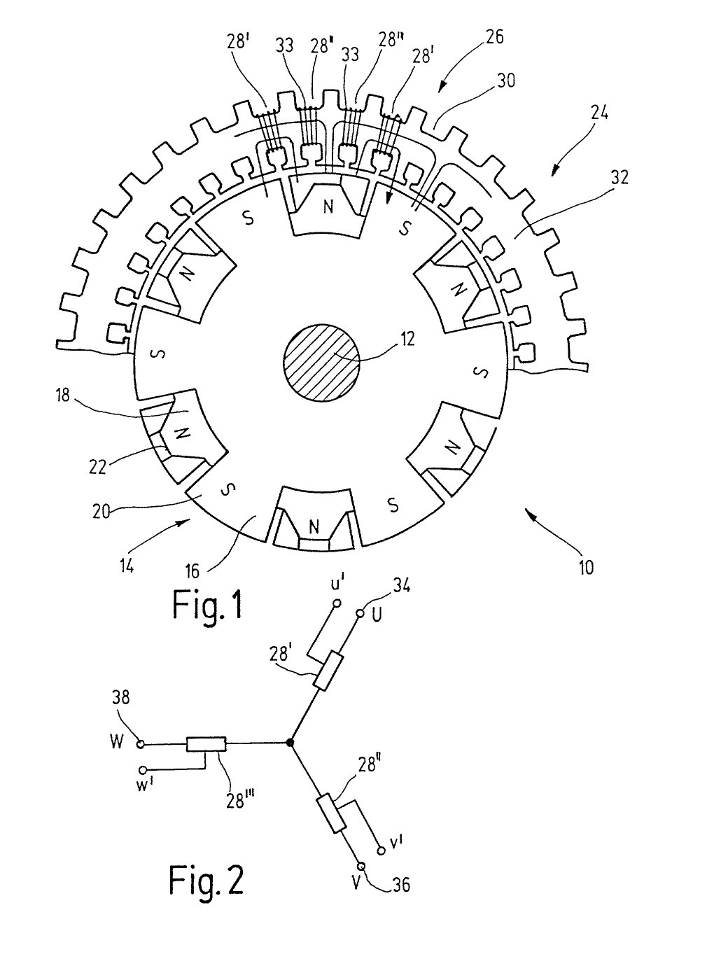

FIG. 1 shows a schematic detail of a section through a three-phase generator 10. The three-phase generator 10 has claw-pole rotor 14 disposed on a drive shaft 12 so that it is fixed against relative rotation. The claw-pole rotor 14 has claw poles 20 and 22 that alternatingly extend from pole disks 16 and 18 coaxial to the drive shaft 12. By means of an excitation winding—not shown in FIG. 1—disposed on the drive shaft 12, which winding is powered with direct current, the claw poles are magnetized so that magnetic north poles N and magnetic south poles S are disposed alternatingly over the circumference of the claw-pole rotor 12.

The claw-pole rotor 14 is encompassed by a stator 24, which supports a winding packet 26. The winding packet 26 is composed of a number of windings 28 which are disposed in grooves 30 of a stator lamination bundle 32.

According to other exemplary embodiments, not shown, the disposition of the winding packet 26 can deviate from the one depicted. It is crucial that the windings 28 are penetrated by the magnetic field emanating from the claw-pole rotor 14.

The windings 28 are comprised of winding wires 33 and 42, which are connected in a manner that will be explained below.

According to the number of claw poles 20 and 22 a corresponding number of windings 28 are provided, which in a three-phase generator, are connected together into three phases U, V, and W. The basic wiring diagram is shown in FIG. 2. According to this depiction, the windings 28 are connected in a star shape in three strands 28′, 28″, and 28′″ so that the phase voltages u, v, and w can be respectively tapped at phase terminals 34, 36, and 38. It is clear that the winding strands 28′, 28″, and 28′″ shown in FIG. 2 are constituted by a corresponding number of series connected windings 28 of the winding packet 26. As a result, partial generator voltages u′, v′, w′ can be tapped between the series connected windings. Furthermore, other connections, for example a triangular connection, are also possible.

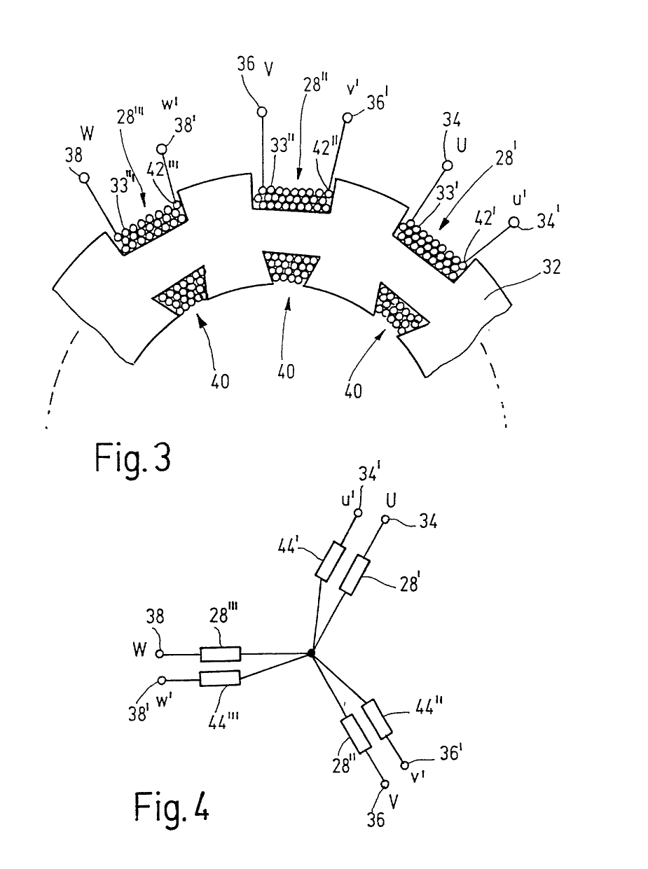

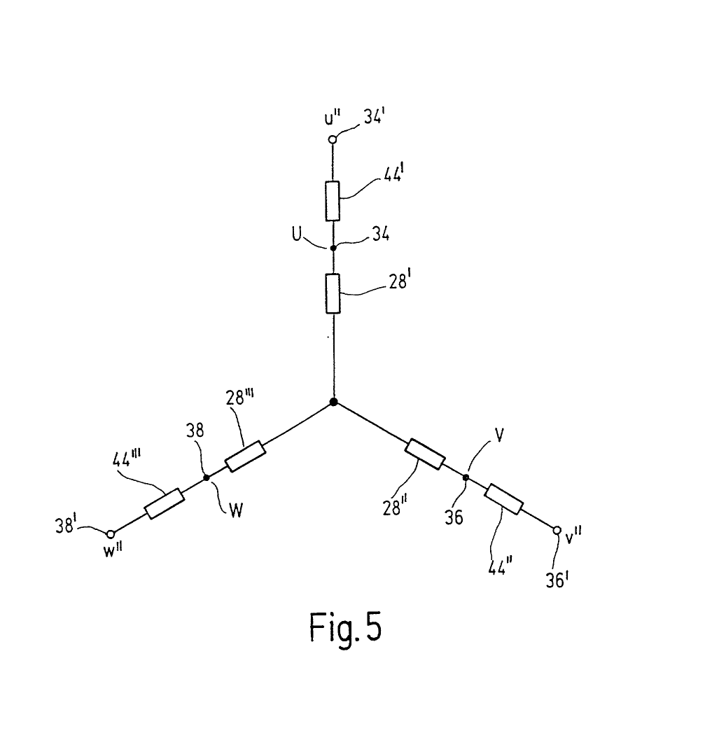

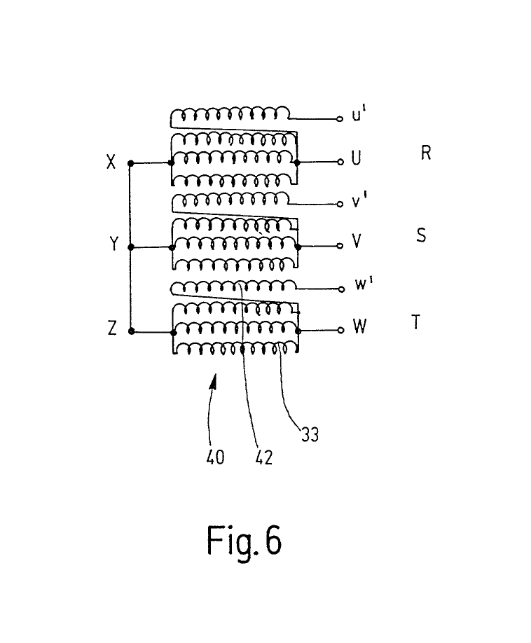

In an enlarged schematic depiction, FIG. 3 clearly shows that the windings 28 are constituted by the winding wires 33. A number of winding wires 33 are respectively combined into a conductor bundle 40, which is wound into the grooves 30 in a number of windings. This means that the winding wires 33 of the conductor bundles of the individual phases U, V, and W are respectively disposed in parallel and are connected together in the phase terminals 34, 36, and 38, respectively. In this connection, however, not all winding wires 33 are connected to the phase terminals 34, 36, and 38, but at least one winding wire 42′, 42″, or 42′″ of each phase U, V, W is connected to a separate phase terminal 34′, 36′, or 38′. Consequently, a load-independent phase voltage u′, v′, or w′ can be tapped at the phase terminals 34′, 36′, and 38′, respectively.

According to different exemplary embodiments, the number of the winding wires 33, which are connected together to the phases U, V, and W, or the number of winding wires 42, which are connected together to the phases U′, V′, and W′, can vary. At least one out of all of the winding wires (winding wires 42) of the conductor bundle 40 is connected to the phases U′, V′, and W′. The winding wires 33 thus constitute a main winding 28 while the winding wires 42 constitute an auxiliary winding 44.

FIG. 4 depicts the circuit arrangement produced by the division into the main winding and auxiliary winding. The winding wires 42 are combined into windings 44 that produce the auxiliary winding.

According to the circuit arrangement shown in FIG. 4, either the generator (phase) voltages u, v, w present at the phases U, V, W or the generator (phase) voltages u′, v′, w′ present at the phases U′, V′, W′ can now be tapped as needed by way of external switching means that are not shown.

According to the circuit arrangement shown in FIG. 5, it is likewise possible to connect the windings 28 or 44 in series by way of switching means that are not shown so that the phase U″ is present at the phase terminal 34′, the phase V″ is present at the phase terminal 36′, and the phase W″ is present at the phase terminal 38′. Consequently, a generator voltage u″, v″, and w″ can be tapped, wherein the voltage u″ is made up of the sum of the voltages u and u′, the voltage v″ is made up of the sum of the voltages v and v′, and the voltage w″ is made up of the sum of the voltages w and w′.

Through simple means, it is possible to tap a total of three different generator voltages from the three-phase generator 10. Since the windings 28 and 44 are constituted by individual, i.e. at least one, parallel connected winding wires 33 and 42, the winding technique that is suited for a series production can also be used to manufacture the winding packet 26 without requiring changes in the winding technique or structural changes in the three-phase generator. Only the phase terminals 34′, 36′, and 38′, which are also routed to the outside, and the switching means, which are necessary for the switching between the phase terminals 34, 36, 38 or 34′, 36′, and 38, must be additionally provided. Depending on the desired generator voltage, a simple switching can thus be used to change between a low voltage, a higher voltage, and a voltage made up of the sum of the two voltages. All of the winding wires 33 and 42 preferably have the same size cross section for the sake of better processing.

The production of the conductor bundle 40 from a large number of relatively thin winding wires 33 and 42, furthermore permits the grooves 36 to be filled to a greater degree so that by and large, it is possible to improve the efficiency of the three-phase generator 10.

In the exemplary embodiment according to FIG. 6, the windings of the phases R, S, T of a three-phase generator are respectively wound from one conductor bundle 40 into the grooves of its stator winding packet, wherein each conductor bundle is comprised of three parallel connected winding wires 33 and a winding conductor 42 connected in series with it. In this embodiment, the consumers of the generator, in particular a rectifier circuit for supplying power to a d.c. battery in the vehicle, are connected to the main windings with the terminals U, V, and W. and a phase voltage that is twice as high is supplied at the terminals U′, V′, and W′ of the auxiliary winding for control purposes and in order to supply power to the excitation winding of the generator. Since the winding beginnings and the winding ends are disposed at one and the same end face of the stator winding packet, it is easily possible to achieve the connection according to FIG. 6 there or in a connecting piece disposed there.

1. An electric machine, in particular a three-phase generator, with a winding packet that can be penetrated by a rotating magnetic field, wherein a number of windings of the winding packet are respectively connected together into at least one phase at which a generator voltage can be tapped, and the windings are comprised of a number of parallel wound winding wires, characterized in that out of the at least three parallel wound winding wires (33, 42) of a phase (U, V, W, U′, V′, W′), at least two are connected to separate phase terminals (34, 36, 38, 34′, 36′, 38′) at each of which a partial generator voltage (u, v, w, u′, v′, w′) can be tapped.

2. The electric machine according to claim 1, characterized in that the windings (28′, 28″, 28′″; 44′, 44″, 44′″) of a phase (U, U′; V, V′; W, W′) can be connected in series in order to tap a total generator voltage (u″, v″, w″) that is made up of the partial generator voltages (u, u′; v, v′; w, w′).

3. The electric machine according to one of the preceding claims, characterized in that the windings (28, 44) are constituted by a common conductor bundle (40).

4. The electric machine according to one of the preceding claims, characterized in that the windings (28) constitute a main winding and the windings (44) constitute an auxiliary winding.

5. The electric machine according to one of the preceding claims, characterized in that the main windings (28) have at least two parallel connected winding wires (33).

6. The electric machine according to one of the preceding claims, characterized in that the auxiliary windings (44) have at least one winding wire (42).
